(19) United States
(12) Patent Application Publication
(10) Pub. No.: US 2004/0227334 A1
(43) Pub. Date: Nov. 18, 2004

(54) Automotive vehicle equipped with an air bag and a device facilitating the deployment thereof

(76) Inventor: Francois Chausset, Saint Maur (FR)

Correspondence Address: MORGAN & FINNEGAN, L.L.P., 345 Park Avenue, New York, NY, 10154-0053, US

(21) Appl. No.: 10/801,385

(22) Filed: Mar. 15, 2004

(30) Foreign Application Priority Data
Mar. 19, 2003 (FR) 03 03 348

(51) Int. Cl. B60R 21/16

(52) U.S. Cl. 280/730.2

(57) ABSTRACT

This invention relates to an automotive vehicle featuring a body (10), an interior trim (20) attached to the body (10), an airbag (30) usually located between the body (10) and the interior trim (20), means of inflating said airbag (30) in case of impact, and at least one guide strap (31), typically extending between the body (10) and the interior trim (20), where one end (311) of said guide strap (31) is attached to the body (10), and the other end (312) is attached to the airbag (30), so that when the airbag (30) inflates, it is deployed toward the inside of the vehicle compartment, drawing the strap (31) along with it.

According to the invention, the vehicle includes means of separating the interior trim (20) from the body (10) when the airbag (30) is inflated, in order to facilitate the deployment of the strap (31).

Generally speaking, this invention relates to motor vehicles equipped with airbags.

More specifically, the invention relates to motor vehicles comprising a body, an interior trim attached to the body and inserted between the body and the passenger compartment, an airbag linked to the body and usually located between the body and the interior trim, means of inflating the airbag in case of impact, and at least one guide strap which is usually sandwiched between the body and the interior trim, with one end of the guide strap usually attached to the body and the other to the airbag, where the inflation and deployment of the airbag inside the vehicle draws the strap with it.

Vehicles of this type are known from prior art, and notably include curtain type airbags, attached just under the roof of the vehicle along the lateral surfaces of the body, and essentially covering the entire length of the roof. When inflated, these airbags deploy downwards as shown in FIG. 11.

Typically, each airbag in the vehicle has front and rear straps that are deployed along with the airbag to restrain it once inflated. Since the air is designed to be totally inflated within the few milliseconds following impact, it is especially important to the safety of the occupants that nothing hinder its movement.

However, these straps are coiled up between the interior trim and the body. Upon inflation of the airbag, the straps undergo a general twisting motion downwards. This twisting motion is hindered by the lack of space between the interior trim and the body, and especially by the horizontal structural ribs in the interior trim that extend between the trim and the body, which slows down the movement of the rear strap.

In this context, the invention proposes to remedy the aforementioned defect, and to facilitate the deployment of the airbag.

To achieve this, the vehicle according to the invention, which otherwise complies with the generic definition given in the preamble above, is essentially characterized by the fact that it comprises means of separating the interior trim from the body when the airbag is inflated, thereby facilitating the travel of the strap.

According to one potential embodiment of the invention, the means of separating the interior trim from the body includes a floating ramp attached to the body and capable of moving away from the body when going from its standby position (relatively closer to the body) to its deployed position (relatively farther away from the body), wherein the interior trim is attached to the floating ramp, and the inflation of the airbag forces the floating ramp from its standby position to its deployed position.

Appropriately, the floating ramp uses mechanical stops to limit the travel of the floating ramp when going from its standby position to its deployed position.

Preferably, the means used to separate the interior trim include: a fixed ramp attached to the body and equipped with a first locking device, the floating ramp equipped with a second locking device which acts with the first one in order to temporarily lock the floating ramp in its standby position as long as the force of the airbag against the interior trim remains below a predetermined threshold value, and to unlock the floating ramp from its standby position when the force of the airbag against the interior trim exceeds the initial predetermined threshold value.

For example, the floating ramp includes a casing which houses the second locking device and to which the interior trim is attached, and at least one lower lug incorporated in the casing, and sliding into a corresponding slot in the fixed ramp, wherein the moveable ramp rests on a base in the housing by means of the lug, and goes from its standby position to its deployed position by pivoting on said lower lug.

Appropriately, the interior trim includes at least a first panel which is securely attached to the floating ramp, a second panel adjoining the first component and facing the airbag in such a way as to be forced away from the body when the airbag inflates, and means of connecting the first panel to the second panel, so that the force acting on the second panel is transmitted to the first panel until said force exceeds a second predetermined threshold, higher than the first, wherein said connection, once the second threshold is reached, activates the separation of the first and second panels, thereby creating an opening through which the airbag is deployed in the passenger compartment of the vehicle.

In a preferred embodiment, the top of the floating ramp faces the airbag and extends from the body to an area of the interior trim where the opening is created when the airbag is inflated.

For example, on the interior trim side, the top surface of the floating ramp includes an inner edge, with the first panel including an upper edge that extends parallel and close to the inner edge, where the second panel includes a lower edge that is engaged between said inner and upper edges.

Appropriately, the first panel includes at least one retaining lug which elastically clicks into a corresponding opening in the floating ramp.

In a preferred embodiment, the second locking device consists of a locking tab, with the first locking device consisting of a corresponding lock opening into which the retaining lug clicks when the floating ramp is in the standby position.

Other characteristics and advantages of the invention shall be clarified in the following description which is given solely as an example and does not limit the scope of application of the invention, and which references the attached drawings wherein:

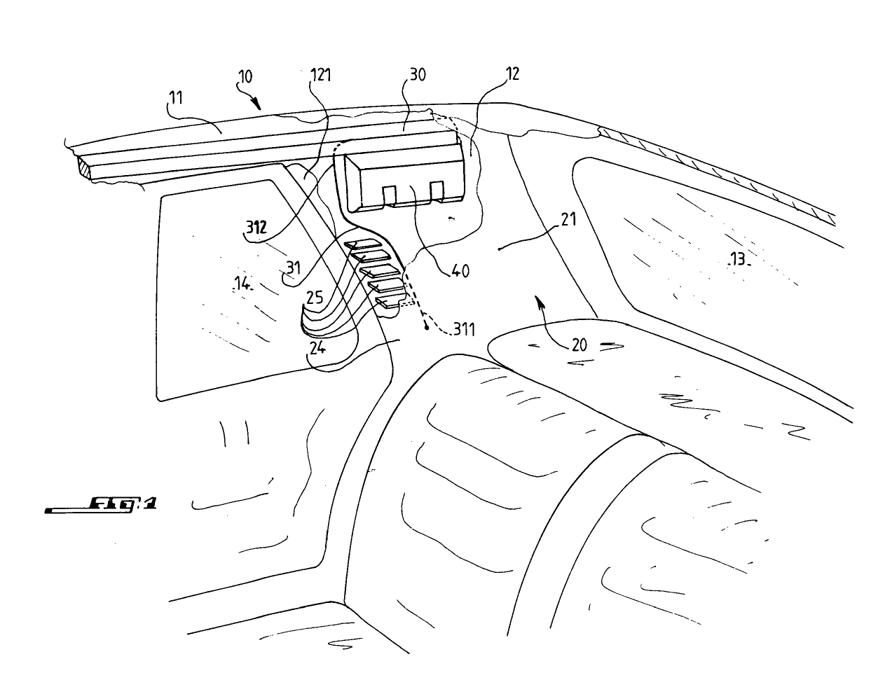

FIG. 1 is a perspective view of the rear part of a vehicle according to the invention;

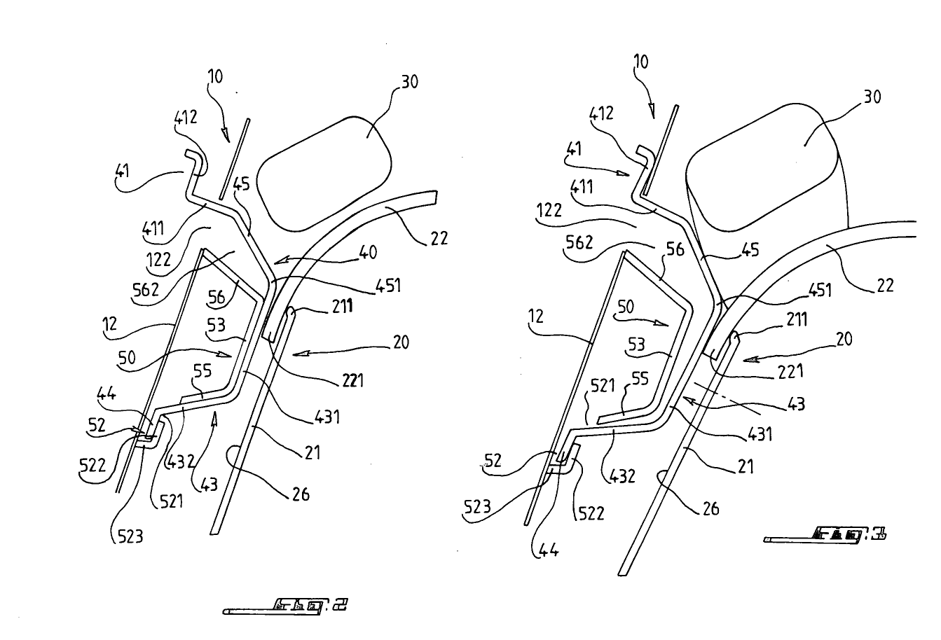

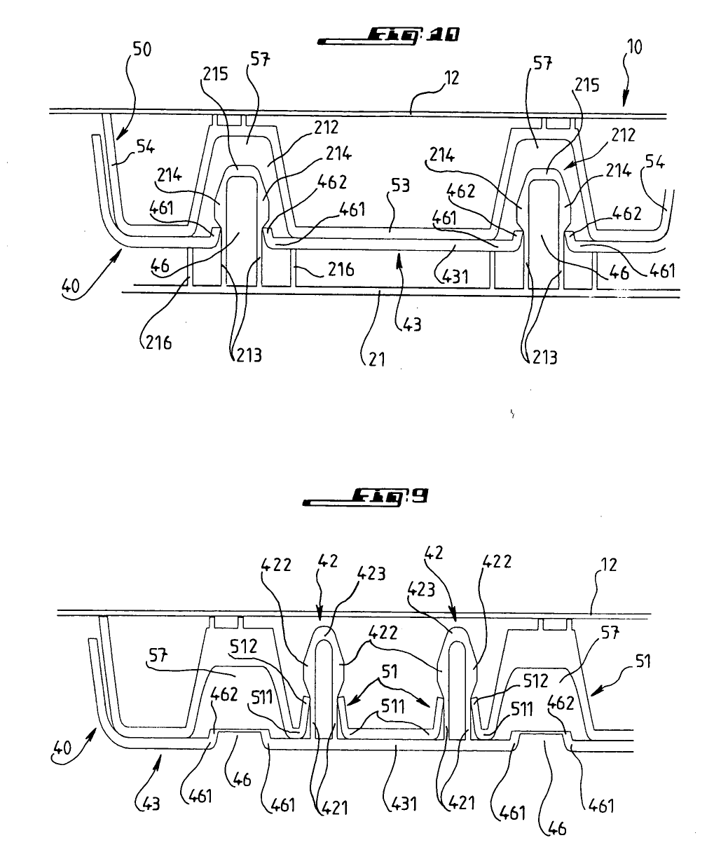

FIG. 2 is a partial cross-section in the transversal plane of the airbag, and of the means used to open the interior trim, according to the direction shown by arrows (II) in FIG. 8, with the airbag non-inflated;

FIG. 3 is a view similar to that in FIG. 2, wherein the airbag is partially inflated and the floating ramp is in the deployed position;

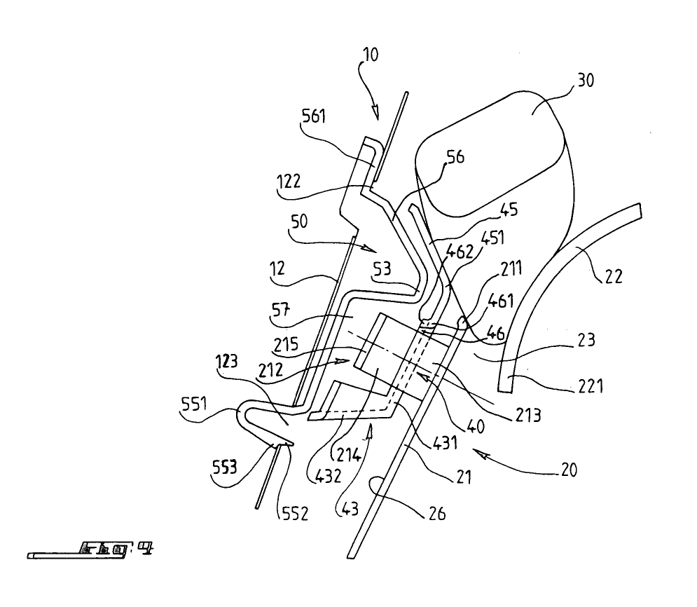

FIG. 4 is a cross-sectional view similar to that in FIG. 2, but according to arrows (IV) shown in FIG. 8, wherein the airbag is a little more inflated and the two parts of the interior trim are both opened in order to allow the airbag to pass through;

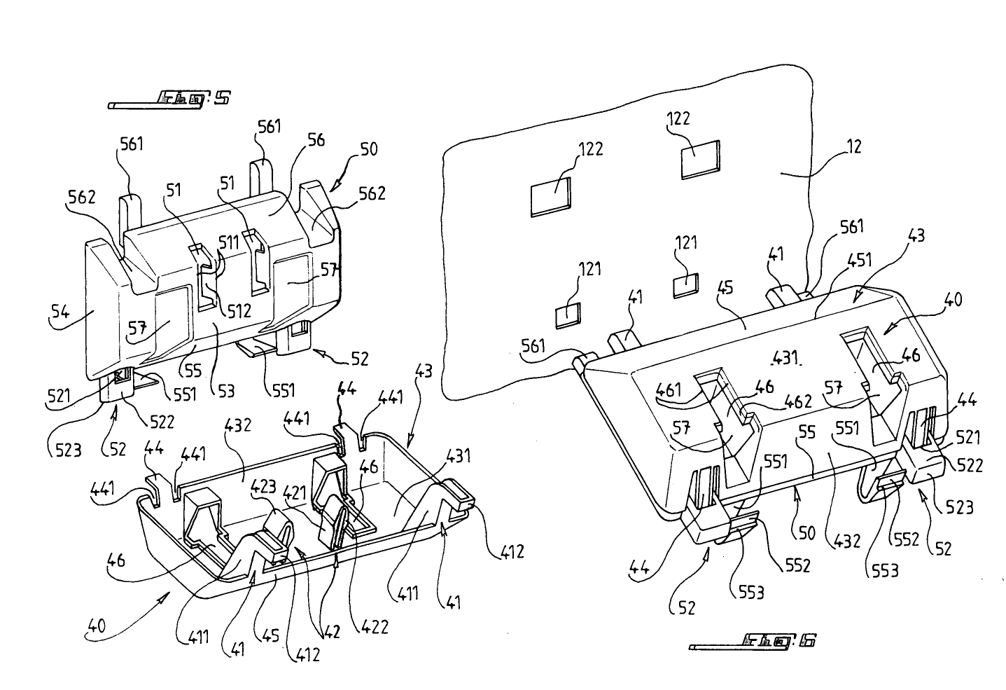

FIG. 5 is a perspective view of non-assembled fixed and floating ramps;

FIG. 6 is a perspective view of that part of the body to which the fixed ramp is attached, and of the fixed and floating ramps after assembly;

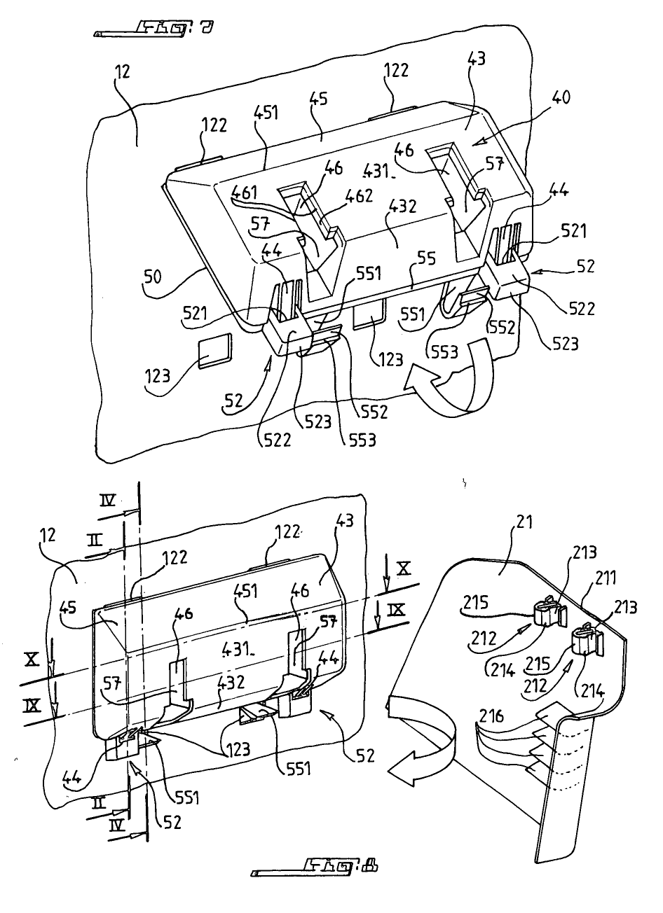

FIG. 7 is a perspective view of the fixed and floating ramps once assembled and partially installed on the body;

FIG. 8 is a perspective view of the fixed and floating ramps once assembled and installed on the body, and of that part of interior trim which is attached to the floating ramp,

FIG. 9 is a cross-sectional view of the body and of the fixed and floating ramps according to the direction shown by arrows IX in FIG. 8;

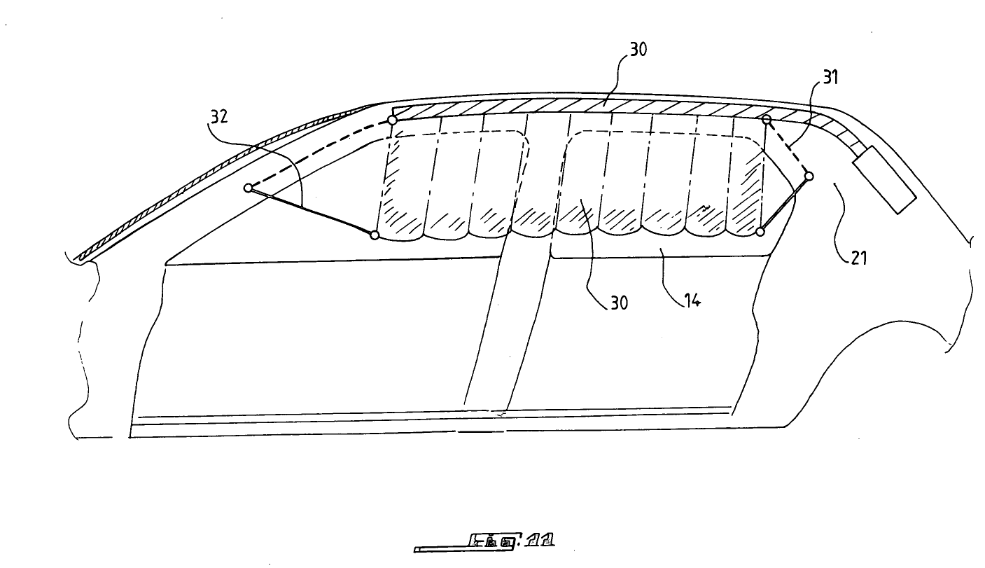

FIG. 10 is a cross-sectional view of the body, the fixed and floating ramps, and that part of interior trim which is attached to the floating ramp, according to the direction shown by arrows (X) in FIG. 8, and;

FIG. 11 is a lateral view of the interior of the vehicle showing the airbag in both standby and deployed positions, and the corresponding positions of the front and rear straps in both cases.

The motor vehicle whose interior is depicted in FIG. 1 includes: a body (10); an interior trim (20) which is attached to the body (10) and separates the body from the interior of the vehicle; an airbag (30) attached to the body and placed between the body (10) and the interior trim (20); means of inflating the airbag (30) in case of impact, and at least one guide strap (31) which extends between the body (10) and the interior trim (20), wherein one end (311) of the strap (31) is attached to the body (10), and the opposite end (312) is attached to the airbag (30).

The means used to inflate the airbag (30) can, for example, consist of an existing pyrotechnical device which triggers the inflation of the airbag (30) should the vehicle be subjected to impact.

The body (10) includes at least the top or “roof” of the vehicle (11), and a rear pillar (12) which is attached to the top (11) and located between the rear window (13) and the right rear door (14).

The interior trim (20) covers both the top (11) and the rear pillar (12). Amongst other things, it includes the rear quarter panel upholstery and the roof liner.

Normally, the airbag (30) stays in its folded position. In the example given in FIG. 11, the airbag (30) is in the folded position and attached to the side of the body, immediately below the top (11) of the vehicle. It extends along the entire length of the top (11), above the doors of the vehicle.

It inflates in case of impact and deploys inside the vehicle, towards the bottom with respect to its folded position, along the right side of the vehicle.

The airbag (30) is guided by two straps; a front strap (32) which is attached to that part of the airbag (30) which represents the leading edge of the airbag (30) when in the deployed position, and a second strap (31) which is attached to that part of the airbag (30) which constitutes the rear edge of the airbag when it is deployed.

Both straps (31, 32) are coiled between the body (10) and the interior trim (20) when the airbag (30) is in the standby position, and are held against the body by means, such as adhesive tape, which will become easily frangible should the airbag deploy.

As shown in FIG. 1, the first end (311) of the strap (31) is attached to the body (10) using means known to existing technology, under the airbag (30), such as a point corresponding to the middle of the rear pillar (12), along a vertical axis, away from the front edge (121) of the pillar (12) which runs along the door (14).

The front strap (32) is also attached by one end to the body (10), between the windshield and the front door of the vehicle.

As the airbag (30) deploys towards the bottom of the interior of the vehicle, it pulls on the straps, thereby tearing off the adhesive tape and unrolling the straps. More specifically, the airbag (30) pulls on the second end (312) of the strap (31) towards the bottom of the vehicle, thereby making the strap (31) pivot generally downwards with respect to the body (10) and the interior trim (20).

Note that, as shown in FIG. 1, one edge (24) of the interior trim (20) is equipped with structural ribs (25) that run along the door (14). These ribs bridge the gap between the external surface (26) of the interior trim (20) which faces the body (10) and the rear pillar (12) of said body (10). These are parallel and superposed, and run perpendicular to the rear pillar (12) of the body (10), and parallel to the longitudinal axis of the vehicle.

The strap (31), when traveling towards the bottom of the vehicle, must slide between these ribs (25) and the rear pillar (12) of the body (10).

According to the invention, the vehicle includes means of separating the interior trim (20) from the body (10) when the airbag (30) is inflated in order to facilitate the travel of the strap (31).

This particular strap (31) can then slide more easily between the ribs (25) and the rear pillar (12) of the body (10).

More specifically, the means used to separate the interior trim (20) include a floating ramp (40) attached to the body (10) that moves away from said body when going from its relatively close standby position to a relatively more spaced position with respect to the body (10) when deployed.

The interior trim (20) is attached to the floating ramp (40), and the inflation of the airbag pushes the floating ramp (40) from its standby position to its deployed position.

The means used to move the interior trim also include a fixed ramp (50) attached to the rear pillar (12) of the body (10) that houses a first locking device (51).

The floating ramp (40) houses a second locking device (42) which acts in conjunction with the first one in order to temporarily lock the floating ramp (40) in its standby position as long as the force of the airbag (30) against the interior trim (20) is less than an initial predetermined threshold value, and to release the floating ramp (40) from its standby position when the force of the airbag (30) against the interior trim (20) exceeds the initial predetermined threshold value.

Needless to say, the fixed ramp (50) and the floating ramp (40) are sandwiched between the rear pillar (12) and the interior trim (20).

Furthermore, the interior trim (20) includes at least one first panel (21) which is firmly attached to the floating ramp (40), a second panel (22) adjoining the first and positioned in such a way with respect to the airbag (30) that the airbag (30) pushes the second panel (22) away from the body (10) upon inflation, and means of constraints between the first and second panels (21, 22) which transmit the forces acting on the second panel (22) to the first panel (21) until said forces exceed a second predetermined threshold value which is greater than the first, wherein once the second predetermined threshold has been exceeded, the constraints allow the first and second panels (21, 22) to be mutually separated from each other in order to define an opening (23) through which the airbag (30) is deployed inside the vehicle compartment.

When the airbag (30) first begins to deploy, it remains sandwiched between the body (10) and the interior trim (20). Then, the pressure of the airbag (30) exerted on the second panel (22) increases proportionately with the increased volume of the airbag (30), until it exceeds the second predetermined threshold value.

During the second phase, the creation of the opening (23) allows the airbag (30) to deploy inside the vehicle compartment, while the pressure of the airbag against the first panel is either stabilized or decreased.

According to the method of embodiment represented in FIGS. 1 through 10, the first component (21) consists of the quarter panel trim which is parallel to the rear pillar (12), and the second component (22) consists of the roof liner which is parallel to the top (11).

The floating ramp (40), which is positioned beneath the airbag (30), includes an upper side (45) which faces the airbag (30) and extends between the rear pillar (12) of the body (10) and an area on the interior trim in which the opening (23) is created when the airbag (30) is inflated. Hence, upon inflation, the airbag (30) is guided by the upper side (45) of the floating ramp (40) towards the opening (23). It can not inflate between the body and the interior trim.

We shall now describe in detail the fixed ramp (50) and floating ramp (40) with reference to FIGS. 5 through 10.

The fixed ramp (50) consists of a housing composed of a fixed rectangular inner fascia (53) which faces the interior trim (20), vertical front and rear side panels (54), and upper (55) and lower (56) panels which bridge the gap between the body (10) and the inner fascia (53). The fixed ramp (50) is attached to the rear pillar (12) at the rear of the four side panels (54 through 56) of the inner fascia (53).

Note that the upper and lower side panels (55, 56) are slightly sloped towards the outer perimeter of the fixed ramp (50) with respect to the inner fascia (53).

As shown in FIG. 5, the fixed ramp (50) has two L-shaped upper lugs (561) at the rear of the upper side panel (56). Both of these lugs include a first part which is perpendicular to the inner fascia (53) and extends from the side panel (56) in the opposite direction of the inner fascia (53), and a second part extending from the first in parallel with the inner fascia (53) towards the outside of the fixed ramp (50).

The fixed ramp also includes two C-shaped hooks (551), incorporated in the leading edge of the lower side panel (55), as shown in FIG. 4. Both of these hooks have one end attached to said leading edge, the first end extending from the opposite side of the inner fascia (53) towards the exterior of the fixed ramp (50), with the second end (552) being essentially positioned under the first end.

The second end (552) has a leading edge which is thinner on one side with respect to the fixed ramp (50), where a shoulder (553) separates said leading edge from the rest of the hook.

The rear pillar (12) of the body (10) includes two upper openings (122) and two lower openings (123).

As shown in FIGS. 6 & 7, the fixed ramp (50) is attached to the body by means of the upper lugs (561) which engage the upper openings (122), and is wedged against the surface of the rear pillar (12) opposite the fixed ramp (50), and by the attachment hooks (551) that engage the lower openings (123). The other ends (552) are pressed against the corresponding lower edge of the lower openings (123) at the opposite end of the fixed ramp (50), so that their leading edge is included in the angle created by the shoulder (553) and the thinner leading edge. The shoulder (553) is pressed against the body (10) at the opposite end of the fixed ramp (50) and the thinner leading edge engages the lower opening (123) and presses against its lower edge.

The floating ramp (40) has a casing (43) which mirrors and complements the fixed ramp (50), with a rectangular inner floating surface (431) and upper, lower and lateral sides (432) which extend from the four sides of the inner floating surface (431) towards the body (10). In standby position, the floating ramp (40) remains nested in the fixed ramp (50), with the inner floating surface (431) pressed against the inner fascia (53) of the fixed ramp, and the floating sides pressed against the sides (54 through 56) of the fixed ramp (50).

The upper lateral side constitutes the upper side (45) of the floating ramp (40).

The floating ramp (40) includes two straight bottom lugs (44) which are an integral part of the lower side of the floating ramp (432), parallel to the inner fascia (431), and extending outwards from the floating ramp (40).

The fixed ramp (50) includes two housings (52) which are an integral part of the lower leading edge (55) and protrude from the fixed ramp (50) with respect to said edge.

These housings (52) are essentially parallelepiped and attached through an opening in the body (10). Each has an opening (521) on its blind side (522), opposite the open surface.

The lower lugs (44) on the floating ramp (40) slide into the housings (52) through their openings (521) and rest against the bottom surface (523) of each housing (52), opposite the lower side (55).

The floating ramp (40) rests against the bottom surfaces (523) on its lower lugs (44) and goes from its standby position to its deployed position by pivoting on the lower lugs (44).

Note that the opening (521) is located in a part of the closed surface (521) near the lower side (55), and that the part of said closed surface next to the bottom surface (523) is solid.

The lug (44) can not release itself from its housing (52) by sliding on the bottom surface (523).

The lower floating side (423) has notches (441) on both sides of the lugs (44) to receive the sides of the openings (521).

The floating ramp (40) includes means using mechanical stops to limit the travel of the floating ramp (40) between its standby position and its deployed position.

Said means include two L-shaped stop lugs (41) which are incorporated into the upper side (45). Each lug includes a straight joining leg (411) which is incorporated into the upper side (45) at one end, which extends in an essentially perpendicular direction with respect to the lower floating surface (431), and a straight stop leg (412) which is incorporated into the opposite end of the joining leg (411) and perpendicular to said leg.

The joining leg (411) extends away from the lower floating surface (431), starting at its first end, and the stop leg (412) extends outward towards the floating ramp (40) from the joining leg (411).

The joining legs (411) go through the upper openings (122) so that the stop lugs (412) are on a side of the rear pillar (12), opposite the casing (43) of the floating ramp (40).

As shown in FIG. 2, the stop lugs (412) are distanced from the rear pillar (12) when the floating ramp (50) is in the standby position.

When the floating ramp (40) goes from its standby position to its deployed position by pivoting on the lower lugs (44), the stop legs (412) come into contact with the rear pillar (12), thereby blocking the ramp in its deployed position.

Note that two parallel grooves (562) are provided in the upper side (56) of the fixed ramp (50) in order to allow the joining legs (411) to move.

The first and second locking devices (51, 42) of the fixed and floating ramps (50, 40) include, respectively, two lock openings in the inner fixed surface (53), and on the upper side (56), and two corresponding locking legs which are included in the interior floating surface (431) and protrude from it toward the fixed ramp (50).

As shown in FIGS. 2 & 9, each of the lock openings (51) is essentially rectangular, prolonged in a longitudinal direction, perpendicular to the sides of the surface (431) where the lower and upper sides (55, 56) start.

The opposite sides of each opening (51) are defined by parallel lateral edges (511), with the fixed ramp including edges (512) that start at the lateral edges (511) of one side of the inner fixed surface (53) opposite the inner floating surface (431).

The locking tabs (42) consist of a main U-shaped section (421) which is perpendicular to the longitudinal direction, with locking tabs (422) protruding from said main section.

More specifically, the main section (421) includes two parallel flat plates, each being attached to the lower floating surface (431) on one side, and joined by a nose section (423) on the opposite side of said surface. Each plate has a boss (422) on one side of said plate, opposite the other plate, near the nose section (423).

The lateral edges (511) are separated by a transversal space (e1). The edges (512) are tilted towards each other, so that their respective leading edges are separated by a transversal space (e2) which is smaller than (e1).

The width (11) of the main section (421) is smaller than (e2), and, at the height of the boss (422), the width of the locking tab (12) is situated between (e1) and (e2).

The elasticity of the locking tabs (42) holds them inside the lock openings (51) while the floating ramp (40) is in the standby position.

Hence, the bosses (422) of the locking tabs are held behind the edges (512) and are turned toward the edges (512). Hence, the locking tabs (42) are held in their inserted position by the bosses (422).

Note that the bosses (422) have a relatively flat cross-section with respect to the two plates of the main section (421), thereby making it possible to release the locking tabs (42) from the openings (51) with a moderate amount of pressure applied against the floating ramp (40).

The first panel (21) of the interior trim is attached to the floating ramp (50) in the same way. Hence, the first panel (21) is also equipped with two locking tabs (212) that elastically snap into two corresponding slots (46) in the floating ramp (40).

As shown in FIGS. 8 & 10, each of these slots (46) includes an essentially rectangular main opening which is part of the lower floating surface (431), with its longer sides following a longitudinal direction, perpendicular to the sides of the surface (431) where the lower side (432) and upper side (45) of the floating ramp begin. These slots extend to the lower side of the floating ramp.

The lateral sides of the main section of each of these slots (46) are defined by two parallel lateral locating lips (461), with the floating ramp (40) having locating lips (462) that extend from the lateral locating lips (461) on one side of the lower side (431) of the floating ramp, opposite the first panel (21).

Each of the locking tabs (212) has a U-shaped main section (213) which is perpendicular to the longitudinal direction, and locking bosses (214) incorporated into the main locking section.

More specifically, the main section (213) includes two parallel flat plates, each being attached to the first trim panel (21) on one side, and joined by a nose section (215) on the opposite side of said component. Each plate has a boss (214) on one side of said plate, opposite the other plate, near the nose section (215).

The lateral locating lips (461) are separated by a transversal space (e3). The locating lips (462) are tilted towards each other, so that their respective leading edges are separated by a transversal space (e4) which is smaller than (e3).

The width (13) of the main locking section (213) is smaller than (e4), and, at the level of the bosses (214), the locking tab (212) has a width (14) situated between (e3) and (e4). The locking tabs (212) snap into the lock openings (46) so that the locking bosses (214) are turned towards the edges (462) of the lock openings and retained behind said edges. The tabs (212) are then kept in position by the bosses (214).

Note that these locking bosses (214) are given, at least on the first panel (21) side, a much more pronounced profile than the other locking bosses (422) in order to prevent the locking tabs from freeing themselves. Indentations (57) are provided in the inner fixed surface (53) and in the lower side (55), across from the lock openings (46) in order to accommodate the locking tabs (212).

Longitudinal structural ribs (216), located on the surface of the first panel (21) and turned towards the floating ramp (40), extend from each side of the locking tabs (212), and have their leading edges pressed against the floating ramp.

Furthermore, as shown in FIGS. 2 through 4, on the interior trim (20) side, the upper side (45) of the floating ramp (40) is defined by an inner edge (451) which forms a common ridge between the upper side (45) and the inner floating surface (431).

The first panel (21) is defined by an upper edge (211) which extends, at least locally, close to and in parallel with the inner edge (451).

The second panel (22) is defined by a lower edge (221) which, at least on part of its length, is engaged between said lower edge (451) and said upper edge (211), so that the pressure exerted by the airbag (30) against the second panel (22) in the direction opposite the body (10) is transmitted to the first panel (21).

When the pressure exerted by the airbag against the second panel (22) exceeds the second predetermined threshold value, the lower edge (221) of the second panel (22) is released from the first panel (21), as shown in FIG. 4, thereby creating the opening (23) between the lower edge (221) of the second panel (22) and the upper edge (211) of the first panel (21).

Note also that the upper edge (21) is exactly aligned with the upper side (45) of the floating ramp (40), thereby ensuring that the airbag (30) will be precisely guided to the opening (23).

Finally, both the fixed and floating ramps (50, 40) are made of molded thermoplastic material.

One will therefore understand that this invention offers numerous advantages.

When the airbag (30) is inflated, it pushes the second panel (21) toward the inside of the vehicle, thereby initially freeing the locking tabs (42) from their corresponding slots, and pivoting the floating ramp (40) to where the stop lugs (41) contact the body and stop its progression.

Subsequently, the pressure exerted by the airbag against the second trim panel separates the first and second trim panels from each other, and guides the airbag to the opening created by the floating ramp.

The pivoting motion of the floating ramp separates the interior trim from the body, which allows the strap to deploy more easily within the extra space allotted, and more specifically, between the structural ribs of the interior trim and those of the body. There is no risk of the strap being pinched between the ribs and the body, which could otherwise impair the rapid deployment of the airbag.

Furthermore, the first trim panel is firmly attached to the floating ramp by the locking tabs (212), thereby eliminating any risk of it being ejected and injuring the occupants of the vehicle when the airbag deploys.

The shape of the locking tabs and their corresponding slots, as well as the first predetermined threshold value of airbag pressure against the second interior trim panel that initiates the pivoting of the floating ramp, must be determined and validated using appropriate calculation and testing methods.

The dimensions and shape of the locking tabs and corresponding slots, as well as the second predetermined threshold value of the airbag pressure against the second interior trim panel required to separate the first and second trim panels, must also be determined and validated using appropriate calculation and testing methods.

Note that the fixed ramp can be easily attached to the body, and that the floating ramp can be just as easily installed on the fixed ramp. although the description of this invention has basically related to curtain-type airbags attached to the roof of a vehicle, it also applies to airbags located in any other part of the vehicle.

1. A motor vehicle including: a body, interior trim panels attached to the body, and separating the body from the interior of the vehicle; an airbag attached to the body, and normally located between the body and the interior trim; means of inflating the airbag in case of impact, and at least one guide strap, usually extending from the body to the interior trim, where one end of said strap is attached to the body, and the opposite end of the strap is attached to the airbag, where the inflation of the airbag makes it deploy towards the vehicle compartment, thereby drawing the strap with it, wherein means of separating the interior trim from the body are provided, in order to facilitate the deployment of the strap when the airbag is inflated.

2. A vehicle according to claim 1, wherein the means of separating the interior trim include a floating ramp attached to the body and capable of pivoting away from said body from a standby position, relatively close to the body, to a deployed position, relatively further from the body, where the interior trim is attached to the floating ramp, and the airbag pushes the floating ramp from its standby position to its deployed position when it is inflated.

3. A vehicle according to claims 2, wherein the floating ramp includes means of stopping the travel of the floating ramp between its standby and deployed positions.

4. A vehicle according to claim 2, wherein the means of separating the interior trim include a fixed ramp attached to the body and bearing a first locking device, with the floating ramp bearing a second locking device, acting with the first in order to temporarily lock the floating ramp in its standby position as long as the pressure exerted by the airbag against the interior trim remains below a first predetermined threshold, and freeing the floating ramp from its standby position once the pressure exerted by the airbag against the interior trim exceeds the first predetermined threshold.

5. A vehicle according to claim 4, wherein the floating ramp includes a casting that houses the second locking device and to which the interior trim is attached, and at least one bottom lug incorporated into the casting, and engaged into a corresponding housing in the fixed ramp, the floating ramp resting against the bottom of the housing by means of said lug, and going from its standby position to its deployed position by pivoting on said bottom lug.

6. A vehicle according to claim 4, wherein the interior trim includes at least a first panel which is secured to the floating ramp, a second panel next to the first panel which is secured to the floating ramp, a second panel next to the first and positioned with respect to the airbag in such a way that upon inflation, the airbag pushes the second panel away from the body, and a means of connecting the first and second panels that transmits to the first panel the pressure applied to the second panel until said pressure exceeds a second predetermined threshold which is higher than the first, where beyond the second threshold, the means of connection allow the first and second panels to be mutually separated, thereby defining an opening through which the airbag is deployed inside the vehicle.

7. A vehicle according to claim 6, wherein the floating ramp includes an upper side which faces the airbag and extends between the body and an area of the interior trim in which the opening is created when the airbag is inflated.

8. A vehicle according to claim 7, wherein the upper side of the floating ramp is defined, on the side of the interior trim, by an inner edge, the first panel having an upper edge which is parallel and close to the inner edge, the second panel having a lower edge fitted between said inner edge and said upper edge.

9. A vehicle according to claim 6, wherein the first panel includes at least one locking tab which snaps into a corresponding lock opening in the floating ramp.

10. A vehicle according to claim 4, wherein the second locking device is composed of a locking tab, the first locking device being a corresponding lock opening in which snaps the locking tab when the floating ramp is in the standby position.

11. A vehicle according to claim 3, wherein the means of separating the interior trim include a fixed ramp attached to the body and bearing a first locking device, with the floating ramp bearing a second locking device, acting with the first in order to temporarily lock the floating ramp in its standby position as long as the pressure exerted by the airbag against the interior trim remains below a first predetermined threshold, and freeing the floating ramp from its standby position once the pressure exerted by the airbag against the interior trim exceeds the first predetermined threshold.

12. A vehicle according to claim 5, wherein the interior trim includes at least a first panel which is secured to the floating tram, a second panel next to the first panel which is secured to the floating ramp, a second panel next to the first and positioned with respect to the airbag in such a way that upon inflation, the airbag pushes the second panel away from the body, and a means of connecting the first and second panels that transmits to the first panel the pressure applied to the second panel until said pressure exceeds a second predetermined threshold which is higher than the first, where beyond the second threshold, the means of connection allow the first and second panels to be mutually separated, thereby defining an opening through which the airbag is deployed inside the vehicle.

13. A vehicle according to claim 7, wherein the first panel includes at least one locking tab which snaps into a corresponding lock opening in the floating ramp.

14. A vehicle according to claim 8, wherein the first panel includes at least one locking tab which snaps into a corresponding lock opening in the floating ramp.

15. A vehicle according to claim 5, wherein the second locking device is composed of a locking tab, the first locking device being a corresponding lock opening in which snaps the locking tab when the floating ramp is in the standby position.

16. A vehicle according to claim 6, wherein the second locking device is composed of a locking tab, the first locking device being a corresponding lock opening in which snaps the locking tab when the floating ramp is in the standby position.

17. A vehicle according to claim 7, wherein the second locking device is composed of a locking tab, the first locking device being a corresponding lock opening in which snaps the locking tab when the floating ramp is in the standby position.

18. A vehicle according to claim 8, wherein the second locking device is composed of a locking tab, the first locking device being a corresponding lock opening in which snaps the locking tab when the floating ramp is in the standby position.

19. A vehicle according to claim 9, wherein the second locking device is composed of a locking tab, the first locking device being a corresponding lock opening in which snaps the locking tab when the floating ramp is in the standby position.
